(19) United States
(12) Patent Application Publication
(10) Pub. No.: US 2003/0089644 A1
(43) Pub. Date: May 15, 2003

(54) Vibratory belt separator apparatus

(76) Inventor: Norman C. Hanks, Seattle, WA (US)

Correspondence Address: DOWREY RICKARDS, 19119 NORTHCREEK PARKWAY, SUITE 106, BOTHELL, WA, 98011, US

(21) Appl. No.: 10/293,386

(22) Filed: Nov. 12, 2002

Related U.S. Application Data
(60) Provisional application No. 60/338,030, filed on Nov. 13, 2001.

(51) Int. Cl. B07B 1/54

(52) U.S. Cl. 209/665; 209/382

(57) ABSTRACT

A mobile separator for separating irregular particles of varying sizes using a separator belt conveyor having a plurality of horizontally disposed endless belts in spaced parallel relationship, a rotary vibrator bar located beneath the top runs of the endless belts is rotated in the same direction as the belts and sets up vibrations which agitate the particles as they are conveyed to enhance separation. The top runs of the belts are guided for parallel travel and the bottom runs are guided such that adjacent belts are positioned in superimposed relation for increased spacing to permit free passage of material therethrough. The rotary vibrator bar may be driven by the same power source as the separator belts with speed control means to drive the belts and the vibrator bar at different speeds.

### CROSS REFERENCE TO RELATED APPLICATIONS

This application claims the benefit under 35 U.S.C. 119(e), of U.S. Provisional Application Serial No. 60/338,030 filed Nov. 13, 2001.

### BACKGROUND OF INVENTION

1. Field of the Invention

The present invention relates to a belt-type separator apparatus for separating or classifying materials of different sizes. More particularly, the present invention relates to a vibratory endless belt separator for separating reusable components of materials such as animal stall bedding or other materials composed of different size discrete parts or particles. The present invention is of primary utility in the separating of bedding, such as wood shavings used as animal stall bedding, from animal droppings deposited, usually at random, in the bedding. The separated wood shavings or other bedding material is then reusable as bedding when separated from horse manure for instance.

2. Background Information and Related Art

In the maintenance of animal stalls or other enclosures, it is common practice to utilize such materials as wood chips, wood shavings or even smaller wood or other fibrous particles as bedding for animals. Although not so limited, the invention is ideally adapted for maintenance of horse or other large animal stalls. Bedding of this type ultimately becomes urine soiled with animal manure being randomly deposited throughout the stall area. Thus, periodically the littered bedding in the entire stall area must either be manually sifted to remove the animal droppings or simply disposed of completely. Needless to say, hand sifting and removal of the littered bedding by pitchfork or other manual means becomes a time consuming and expensive procedure. In large facilities such as horse farms, this becomes a labor intensive and costly operation. Accumulation and ultimate disposal of large quantities of littered wood chips or shavings of this type may also become an environmental hazard over a period of time.

One alternative to manual removal of littered stall bedding, of course, is to separate the accumulated manure from the wood chips or wood shavings by motor driven sifting apparatus, leaving the reusable shavings in the stall and discarding only the waste material. Although vibratory screens or bars, such as disclosed in the Lewis et al U.S. Pat. No. 4,897,183 and the Hart U.S. Pat. No. 5,927,513, have been designed for use in separating animal droppings from different types of bedding material such as wood shavings and sawdust, a need has arisen for a more efficient and inexpensive portable separator for in-stall use.

In addition to vibratory screens or parallel shaker rods, moving belts and conveyor type separators have been utilized for separating or classifying various materials or particulate objects. Belt and/or chain type conveyors used for separating purposes may also include vibratory features such as illustrated by the Brul é U.S. Pat. No. 4,593,821 and the Laure et al U.S. Pat. No. 4,717,027. These devices, however, have not been particularly adapted for use in separating and recovering reusable wood shavings or wood chips commonly used as bedding material in animal stalls.

### SUMMARY OF INVENTION

The present invention provides a self-contained mobile separator apparatus of particular utility for separating reusable components of materials such as, but not limited to, animal stall bedding composed of different size discrete parts or particles. A belt conveyor having a plurality of horizontally disposal endless belts in side-by-side space parallel relationship is mounted in a frame defining a bin or box for receiving the material to be separated. A rotary vibrator bar having one or more contact surfaces is located beneath the top runs of the endless belts and is rotated in the same direction as the belt travel. The vibrator bar sets up vibrations in the belts which agitate the particles as they are conveyed to enhance separation with smaller particles falling between the belts and larger particles being unloaded at a discharge location. The top runs of the belts are guided for parallel travel and the bottom runs are guided such that adjacent belts are positioned in superimposed relation for increased spacing to permit free passage of material therethrough. The rotary vibrator bar may be driven by the same power sources as the separator belts with speed control means to drive the belts and the vibrator at different speeds. The separator belts may be hollow or solid flexible material and preferably somewhat elastic to enhance the vibration characteristics.

### BRIEF DESCRIPTION OF DRAWINGS

FIG. 1 is a perspective view of the separator apparatus of the present invention as viewed from the out feed or discharge end of the separator;

FIG. 2 is a perspective view of the separator from the infeed or loading end;

FIG. 3 is a side elevation of the separator with parts broken away to illustrate the motor drive train for the separator belts;

FIG. 4 is a perspective view of the conveyor belt system and vibrator bar;

FIG. 5 is top plan view of the separator belt system; and

FIGS. 6-7 illustrate the operation of the vibrator bar on the conveyor belt system.

### DETAILED DESCRIPTION

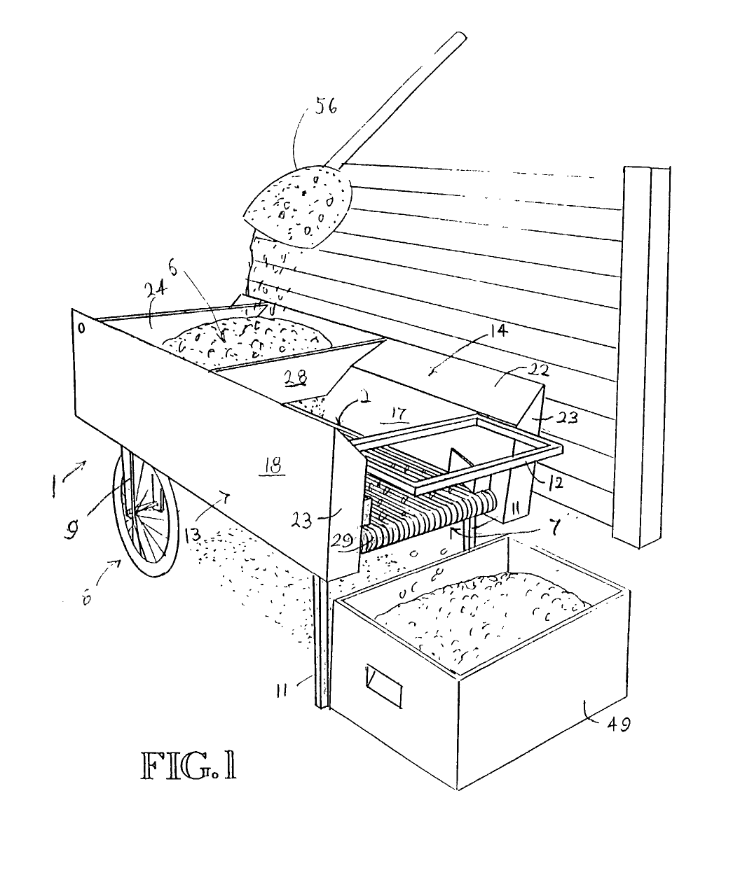

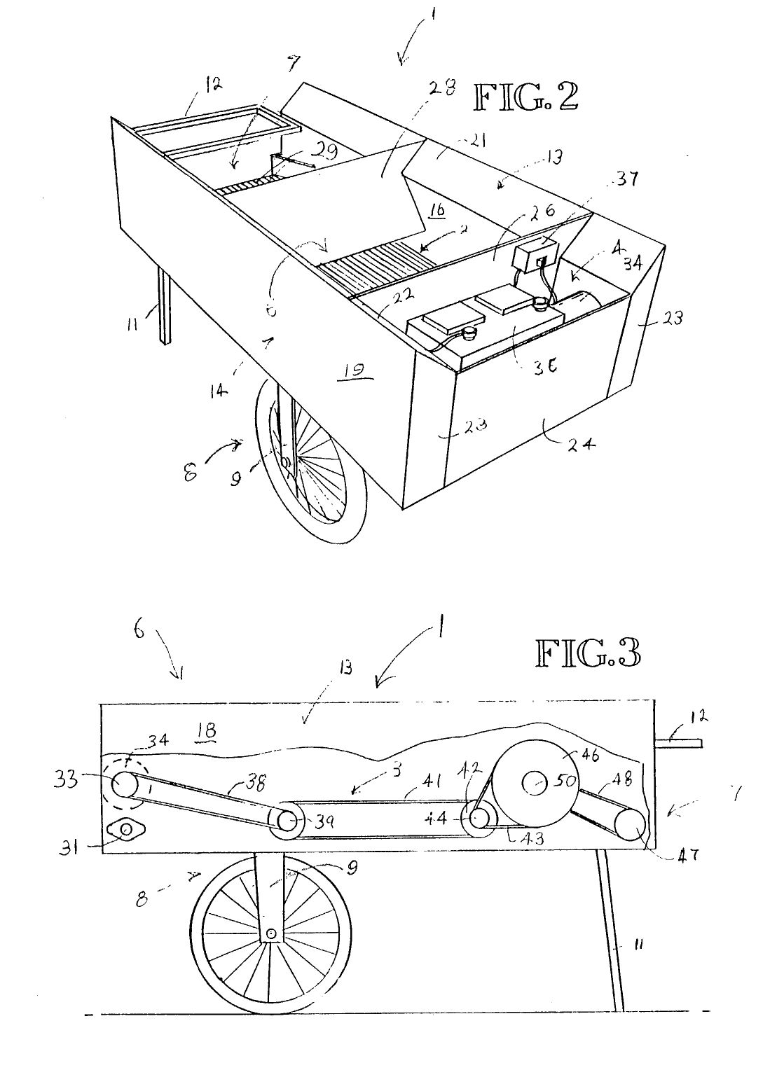

Referring to FIGS. 1 and 2, the apparatus comprises a separator box frame indicated generally at 1 forming hopper means for receiving the littered stall bedding or other material to be separated. The separator box frame 1 provides a mounting for the vibratory belt separator indicated generally at 2, presently to be described in detail, along with its drive means 3 illustrated in FIG. 3 and the drive motor system 4 shown in FIG. 2. The box frame 1 forms a hopper means for receiving the material to be separated at an infeed or loading area indicated generally at 6 and discharged at the out feed end 7. The material which fails to pass through the separator is discharged by the vibratory belt section 2 and is collected for disposal as illustrated in FIG. 1.

In the preferred embodiment, the separator box frame may be made portable so as to be conveniently moved between stalls or from one location to another by such means as the support wheel assemblies 8 mounted in suitable wheel brackets 9 attached to the bottom side of one end of the separator box 1. It will be understood, however, that any suitable form of fixed or wheeled support structure may be utilized other than that illustrated and any number of support wheels may be attached as desired. For instance, instead of the two sets of wheel assemblies illustrated, a single wheel assembly in the nature of a wheelbarrow configuration may be utilized well within the purview of the invention. Additionally the support structure may be adjustable for height if desired.

The opposite end of the separator box 1 may be supported by suitable fixed legs 11 as illustrated. The legs 11, of course, may be either rigidly attached to the bottom of the separator box, may be made adjustable for height or even hingedly attached to the box as desired. In the illustrated embodiment, a handle 12 is attached to the opposite end of the separator box from the wheel assemblies in order to enable an operator to lift the box and move the separator from location to location. The handle 12 may, however, be attached to either end of the separator box as desired. In the present preferred embodiment, the handle 12 may take the form of a rectangular frame which is welded or bolted between the side panels of the box. It will be understood that the handle means may take any desired form other than that shown for any particular embodiment and may be attached to the box frame in any suitable manner such as a pivotal or articulated mounting well within the skill of an artisan.

Although the details of construction may vary, the separator box 1 may be conveniently constructed from sheet metal or other sufficiently strong and rigid sheet material either with or without separate support struts or bracing. In the illustrated embodiment, the separator box includes the parallel upstanding rectangular side frame units 13 and 14. Frame units 13 and 14 are double walled structures for a purpose presently to be described and will include inside wall panels 16 and 17 respectively as well as parallel outside panel walls 18 and 19 respectively. The upwardly inclined top side walls 21 and 22 of the side frames 13 and 14 respectively connect the inside and outside walls of the frame units along their upper edges and identical front and rear end panels 23 serve to close the double walled side frame units. The walls 21 and 22 may be inclined for the purpose of facilitating the introduction of material to be separated in the loading area 6.

The separator box frame 1 is closed at the loading or infeed end by means of the end wall 24 and a barrier wall 26. These two walls form a compartment for housing the motor drive system indicated generally at 4 which is mounted on a suitable floor panel 27 connected between the side frame units 13 and 14. To complete the separator box frame, a divider panel 28 is connected between the inside wall members 16 and 17 and extends generally from the top edge of the side walls 21 and 22 to a position slightly above the vibratory belt separator 2. Although the divider wall 28 is shown in an inclined position so as to facilitate downward movement of the material to be separated, it will be understood that the separator wall may take any form and be either inclined or vertical without departing from the spirit of the invention. The function of the divider wall 28 is to create a bin structure for receiving the material to be separated and allowing the material to drop down on the moving vibratory belt. The entire separator box frame may be constructed by welding sheet metal panels or may be constructed utilizing bracing or cross members to connect the various panels. Other variations, such as removability of end walls and the like or providing adjustable positioning for the divider wall 28, are also considered to be within the skill of an artisan. Likewise the use of connector means such as welding bolting or the like may be used to connect the panels of the separator box and the divider panels. The use of a double walled structure allows for the mounting and covering of drive shafts, bearings and drive belts for the conveyor system while maintaining a smooth interior surface in the box frame.

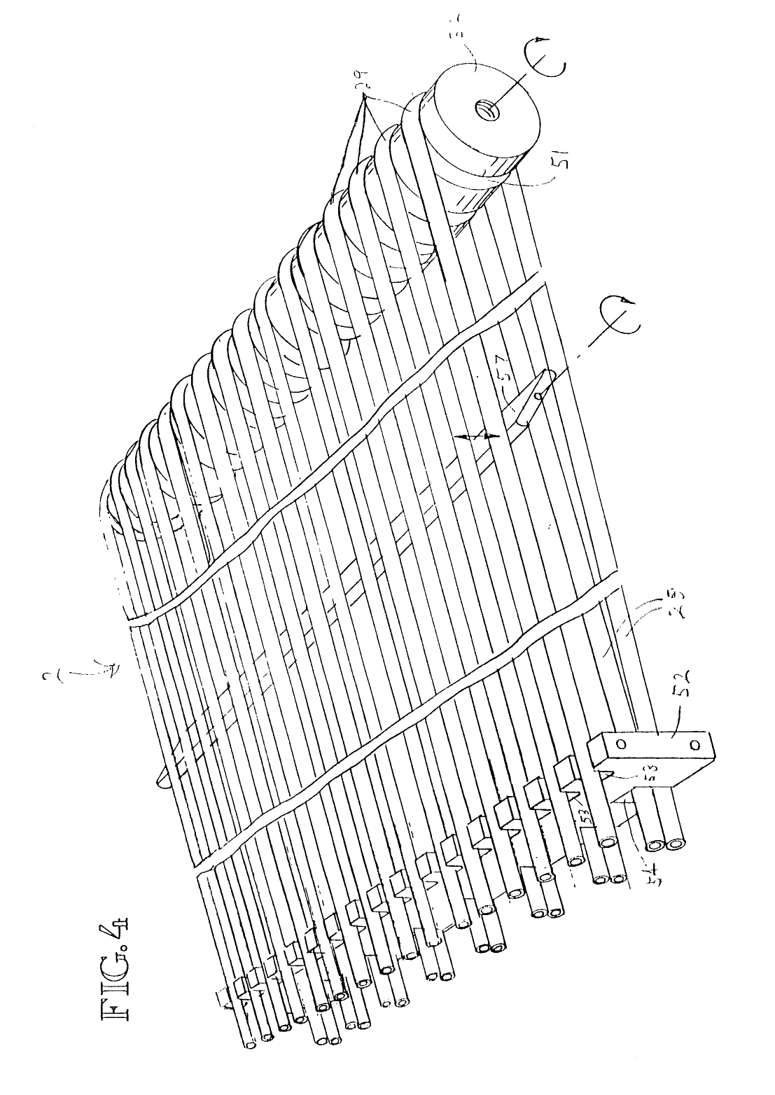

The vibrator belt separator 2 is located essentially in the bottom part of the separator box frame 1 and extends substantially the length of the separator box frame. The exact length of the belt conveyor may vary and will reach from the loading area 6 to a suitable discharge point as a minimum. Referring to FIGS. 3 and 4, a plurality of individual vibratory belt members 29 are trained about a suitable grooved idler roller (not shown) located beneath the motor drive system 4 in the infeed end of the separator box. The idler roller may be journaled in suitable bearings 31 carried by the inside walls 16 and 17 of the separator box as illustrated in FIG. 3. The opposite ends of the endless belts 29 are trained about the grooved drive roller 32 mounted for rotation in a like manner at the opposite end of the separator box frame between the inside panels 16 and 17 of the separator box frame. FIG. 3 is a schematic illustration of the drive train 3 which transfers rotation from a motor drive pulley 33 powered by the electric motor 34 located in the compartment provided between the end wall 24 and barrier wall 26 as illustrated in FIGS. 2 and 5. In the present embodiment the electric motor 34 may be a DC motor powered by the storage battery 36 also located in the compartment between the walls 24 and 26. The battery or power source 36 is connected by appropriate wiring to a switchbox 37 mounted in any convenient location such as the barrier wall 26 shown in FIGS. 2 and 5. With this arrangement, the separator apparatus is completely self contained and portable for movement between animal stalls for instance or other desired locations.

Referring to FIG. 3, the drive motor pulley 33 is connected by means of the drive belt 38 for rotation of a vibrator bar presently to be described via means of the pulley 39 and then to a second rotating vibrator bar by means of the belt 41 trained about a drive pulley 42. Speed reduction is accomplished by means of the belt 43 trained about the pulley 44 and the larger speed reduction pulley 46. The final drive for the conveyor is transferred to the drive pulley 47 connected to the drive roller 32 by means of the final drive belt 48 drivingly connected to a suitable pulley (not shown) on the shaft 50. As illustrated in FIG. 4, the drive roller 32 is driven in a clockwise direction indicated by the arrows in order to move material on the belts 29 over the edge of the out feed end of the separator box as depicted in FIG. 1. A suitable collector or container 49 may be positioned to receive the material exiting from the separator conveyor at the end of the out feed portion of the separator box as shown in FIG. 1. It will be understood that the drive system may take the form of any convenient power source, motor means and a series of pulleys and belts or any other drive transfer means designed to rotate the drive roller 32 in the proper direction so as to discharge the material from the vibratory conveyor belt system 2. Such variations are considered to be within the skill of the artisan and may be altered to suit any particular purpose.

Referring to FIG. 4, the individual belts 29 may be identical and, in the preferred embodiment, comprise circular cross section tubes made of polyurethane or any other suitable plastic, synthetic material or rubber which is flexible and may or may not be slightly elastic. In the illustrated embodiment, the belts 29 are hollow tubular structures and are in the form of endless belts which are positioned by suitable grooves 51 in the drive roller 32 at the out feed end of the separator box. The belts 29 will be similarly positioned by suitable grooves in the idler roller located in the opposite end of the separator box and journaled in the bearings 31. According to the present invention, the top run of the belts 29 as viewed in FIG. 4 are spaced evenly across the tope run of the conveyor to provide a moving surface through which particles of relatively smaller dimensions may pass as the belts carry the material from the infeed or loading area 6 to the out feed discharge end 7 of the separator. Intermediate guides in the form of stationary bars 52, one of which is shown in detail in FIG. 4, are longitudinally spaced along the conveyor between the drive roller 32 and the idler roller on the opposite end of the separator. These guide bars may be located at any convenient or desired location along the vibratory conveyor depending on the structural details of any particular installation. The guide bars 52 are provided with suitable slots 53 in their top edges which are spaced to correspond to the spacing between the grooves 51 and the drive roller 32 and are of sufficient depth to adequately hold the belts 29 in alignment with the desired spacing as the belts are rotated. The bars 52 may be mounted between the inside walls 17 and 18 of the separator box in any convenient manner such as bolting or otherwise clamping in position. In order to provide increased spacing between the moving belts on the lower runs of the conveyor, the bottom edges of the guide bars 52 are constructed and arranged with deeper slots than the top edge. The slots 54 are approximately double the depth of the slots 53 in order to allow two adjacent belts 29 to travel together along their bottom runs. The area through which material is allowed to drop from the top surface of the belt conveyor is thus increased. As depicted in FIG. 1, the smaller particles from the material to be separated such as wood shavings or the like is allowed to fall back down to the stall floor while the larger pieces or clumps of manure are carried along by the conveyor belts and deposited in the container 49. As shown in FIG. 1, the loading area 6 is filled by means of a shovel or the like 56 by hand during the separation process.

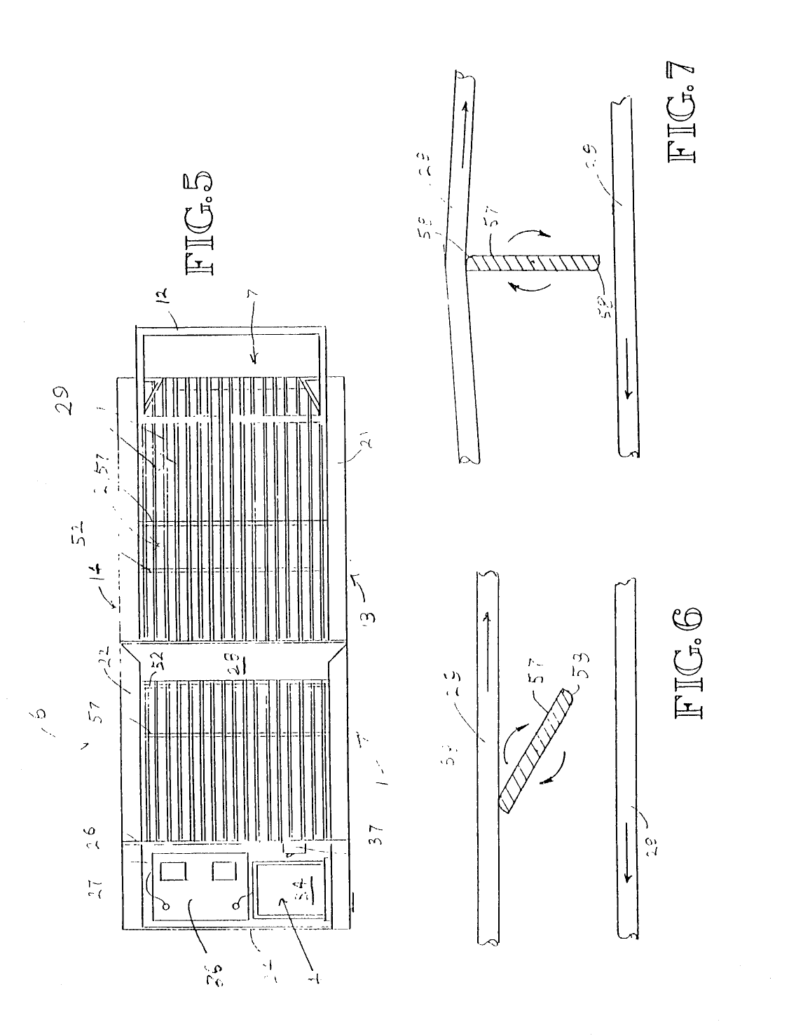

In order to enhance the effective separation of the large particles or clumps within the body of shavings or chips which in many cases may be urine soiled with a tendency to cling, a mechanical vibration is set up in the upper run of the belts 29 as the conveyor surface progresses from the loading section to the out feed end of the separator box. This mechanical vibration is provided by means of one or more rotating vibrator bars such as the two rotating bars 57 located between the guide bars 52 and the drive and idler rollers at the extreme ends of the belt conveyor system. Although the illustrated preferred embodiment discloses the use of two such rotating vibrator bars, it will be understood that any number of bars may be utilized. The bars 57 of the present embodiment are carried on shafts (not shown) rotated by means of the pulleys 39 and 44 as seen in FIG. 3. These shafts and pulleys will be properly journaled in the side walls 16 and 17 of the box frame. As shown in FIGS. 6 and 7, the bars 57 rotate in a clockwise manner so as to rotate in the direction of travel of the top runs of belts 29 as they rotate. The leading longitudinal edges of the bars 57 which initially contact the belts 29 will be chamfered or radiused as at 58 so as to avoid any damage to the surface of the belts. As seen in FIGS. 6 and 7, the rotating vibrator bars 57 extend substantially the entire width of the conveyor belts and simultaneously contact all of the bottom surfaces of the belts along their upper runs only. The rapid intermittent lifting of the belts as shown in FIG. 7 sets up a vibration in the upper runs of the belts only and the frequency of the vibrations may be controlled or determined either by the speed of rotation of the bars 57 or conceivably by the number of surfaces on the rotating bar which contact the undersides of the upper runs of the belts. In any event, this vibratory action is sufficient to dislodge and break up any clumps of material allowing the finer particles to pass through the belts, between the grouped belts of the lower runs and back to the stall floor as illustrated in FIG. 1. This vibrating conveyor system has been found to greatly enhance the ability to rapidly and efficiently separate and collect the animal droppings from wood shavings or the like with a minimum of manual labor.

The descriptions above and the accompanying drawings are to be interpreted in the illustrative and not the limited sense. While the invention has been disclosed in connection with the preferred embodiment thereof, it should be understood that there may be other embodiments which fall within the scope of the invention.

1. In a conveyor apparatus having a plurality of movable endless belt members with side-by-side horizontally spaced upper runs, vibrator means for imparting vertical vibration to the upper run of at least one of said belt members comprising;
a vibrator member located beneath the upper run of said at least one belt member for contacting and imparting vertical vibration thereto, and
drive means for driving said vibrator member for cyclic contact with said at least one belt member during movement thereof.

2. Apparatus for separating particles of varying sizes comprising, in combination;
endless belt separator means through which particles are to pass, said separator means including at least two movably mounted narrow endless belt members having upper runs in side-by-side relation for conveying certain of said particles to a discharge location, and
vibrator means located beneath the upper runs of said endless belts and spaced from said discharge location for contacting at least one of said endless belt members to impart cyclic vertical vibration thereto to agitate said particles during movement on said belt members.

3. The apparatus of claim 2 wherein the upper runs of said endless belt members are substantially parallel, said separator means including guide means for directing adjacent ones of said belt members in vertically superimposed relation along the lower runs thereof,
whereby increased spacing between belt members is provided to facilitate passage of particles passing through the upper runs of the belt members.

4. The apparatus of claim 2 wherein said vibrator means extends the full transverse width of said separator means and contacts the upper runs of each said endless belt members.

5. The apparatus of claim 4 wherein said vibrator means comprises an elongated rotatable vibrator bar having a longitudinal axis of rotation and at least one elongated contact surface spaced from said axis for cyclically contacting said endless belt members during rotation thereof, and
means for rotating said vibrator bar about said longitudinal axis in the direction of travel of said belt members for cyclic vibration thereof.

6. The apparatus of claim 5 wherein said vibrator bar includes a plurality of said contact surfaces.

7. The apparatus of claim 6 including a plurality of said vibrator bars spaced along the upper runs of said belt members.

8. The apparatus of claim 7 wherein the upper runs of said endless belt members are substantially parallel, said separator means including guide means for directing adjacent ones of said belt members in vertically superimposed relation along the lower runs thereof,
whereby increased spacing between belt members is provided to facilitate passage of particles passing through the upper runs of the belt members.

9. Separator apparatus for separating irregularly shaped particles of varying sizes comprising, in combination;
a frame defining an area through which particles are to pass,
separator belt means movably mounted in said frame for permitting first particles to fall therethrough while supporting second particles to be transported to a discharge location,
said separator belt means including at least two narrow endless belts having upper runs in side-by-side relation providing clearance through which said first particles can pass,
belt drive means for supporting and moving the upper runs of said belts relative to said frame toward said discharge location,
a vibrator member for contacting the upper run of at least one separator belt for effecting cyclic vertical vibration thereto, said vibrator member being mounted beneath the upper run of said at least one separator belt and spaced from said discharge location, and
vibrator drive means for driving said vibrator member for cyclic contact with said at least one separator belt during movement thereof toward said discharge location, whereby particles carried by said separator belt means will be agitated to enhance passage of said first particles therethrough.

10. The apparatus of claim 9 where the upper runs of said endless belt members are substantially parallel, said separator means including guide means for directing adjacent ones of said belt members in vertically superimposed relation along the lower runs thereof,
whereby increased spacing between belt members is provided to facilitate passage of particles passing through the upper run of the belt members.

11. The apparatus of claim 10 wherein said vibrator member comprises an elongated rotatable vibrator bar having a longitudinal axis of rotation and at least one elongated contact surface spaced from said axis for cyclically contacting said endless belt members during rotation thereof,
said vibrator bar extending across the width of said separator belt, and
means for rotating said vibrator bar about said longitudinal axis in the direction of travel of said belt members for cyclic vibration thereof.

12. The apparatus of claim 11 wherein said vibrator bar includes a plurality of said contact surfaces, said contact surfaces including radiused side edges for direct contact with said belt members.

13. The apparatus of claim 12 including a plurality of said vibrator bars spaced along the upper runs of said belt members.

14. The apparatus of claim 11 wherein;
said frame comprises a bin enclosure for receiving quantities of material to be separated and having an infeed section for reception of said material and an outfeed section containing said discharge location,
said separator belt means defining the bottom of the bin enclosure and extending the length of said infeed and outfeed sections,
said guide means extending across the width of said separator belt means and including a plurality of first guide slots on an upper surface for maintaining the upper runs parallel during movement thereof and a plurality of second guide slots maintaining the lower runs in superimposed relation during movement thereof.

15. The apparatus of claim 14 wherein said belt drive means includes motor means mounted on said frame and drive transmission means connecting said motor means for driving said endless belts,
said bin enclosure includes a double sided wall structure for mounting said drive transmission means.

16. The apparatus of claim 15 wherein said vibrator drive means is connected to said drive transmission means,
said drive transmission means including a speed control device for driving said belts and said vibrator bar at different speeds.

17. The apparatus of claim 16 wherein said belt members are longitudinally elastic.

18. The apparatus of claim 17 wherein said belt members comprise hollow elastic endless bands.

19. The apparatus of claim 1 8 including;
wheeled support structures for supporting said bin enclosure, and
said motor means being battery powered,
whereby said separator apparatus is mobile for operation in selected locations.
